(19) United States
(12) Patent Application Publication
(10) Pub. No.: US 2022/0219727 A1
(43) Pub. Date: Jul. 14, 2022

(54) VEHICLE PATH PLANNING

(71) Applicant: Motional AD LLC, Boston, MA (US)

(72) Inventors: Boaz Cornelis Floor, Singapore (SG); Juraj Kabzan, Singapore (SG); Sirish Srinivasan, Singapore (SG)

(21) Appl. No.: 17/147,426

(22) Filed: Jan. 12, 2021

(51) Int. Cl. B60W 60/00; B60W 30/09; B60W 30/095

(52) U.S. Cl. CPC B60W 60/0011; B60W 30/09; B60W 2555/60; B60W 2554/404; B60W 2720/10; B60W 30/095

(57) ABSTRACT

Among other things, techniques are described for identifying, by at least one processor of a vehicle based on a graph that includes a plurality of edges and a plurality of nodes, a reference path through an environment that includes a subset of the plurality of edges. The technique further includes identifying a first path based on optimization of a spatial model related to the graph and the reference path and a second path based on application of at least one constraint to the reference path. The technique further includes selecting, by the at least one processor, the first path or the second path as a path along which the vehicle will traverse based on a pre-identified rulebook. Other embodiments may be described or claimed.

### FIELD OF THE INVENTION

This description relates to vehicle path planning.

### BACKGROUND

A vehicle such as an autonomous vehicle will utilize a path planning system to identify a path which the vehicle may navigate through an environment. In legacy systems, this path planning system uses a sampling-based approach to identify the path. However, this sampling-based approach may be inefficient, or may encounter inefficiencies in situations where the velocity of the vehicle is very low or approaching zero. Specifically, as the velocity of the vehicle is very low or approaches zero, then the time horizon in space will shrink and the path planning system will be unable to efficiently produce a proposed path beyond that time horizon. Additionally, this sampling-based approach may encounter difficulties when the paths are constricted (e.g., by the presence of another vehicle).

### BRIEF DESCRIPTION OF THE DRAWINGS

FIG. 1 shows an example of an autonomous vehicle having autonomous capability.

FIG. 2 shows a computer system.

FIG. 3 shows an example architecture for an autonomous vehicle.

FIG. 4 shows a block diagram of the relationships between inputs and outputs of a planning system.

FIG. 5 shows a directed graph used in path planning.

FIG. 6 shows an example path planning system, in accordance with various embodiments.

FIG. 7 shows another example of a directed graph to be used in path planning, in accordance with various embodiments.

FIG. 8 shows an example technique for path planning, in accordance with various embodiments.

### DETAILED DESCRIPTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

In the drawings, specific arrangements or orderings of schematic elements, such as those representing devices, systems, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. System Overview
3. Autonomous Vehicle Architecture
4. Autonomous Vehicle Planning
5. Path Planning

### General Overview

A vehicle (e.g., an autonomous vehicle) uses a path navigation system to navigate through an environment. Specifically, a path planning system identifies a reference path through the environment. A constraints computation system then applies at least one constraint to the reference path to identify one potential path through the environment. Additionally, a spatial model predictive control (MPC) system identifies another potential path based on spatial optimization of the reference path. The two potential paths are then compared to identify which path should be used by the vehicle for navigation. In an embodiment, the result from the spatial MPC is further fed back to a path planning system for use in identifying a subsequent reference path.

Some of the advantages of these techniques include an increased ability for the vehicle to navigate through space-constrained environments. Additionally, by allowing an identification, and comparison, of two potential paths, an optimal path through the environment may be identified more quickly, thereby conserving computational resources that would otherwise be used to identify the optimal path through the environment. Finally, because both a velocity-based and spatially-constrained approach are used, the navigation system is able to efficiently navigate through the environment even when the velocity of the vehicle becomes low or approaches 0.

### System Overview

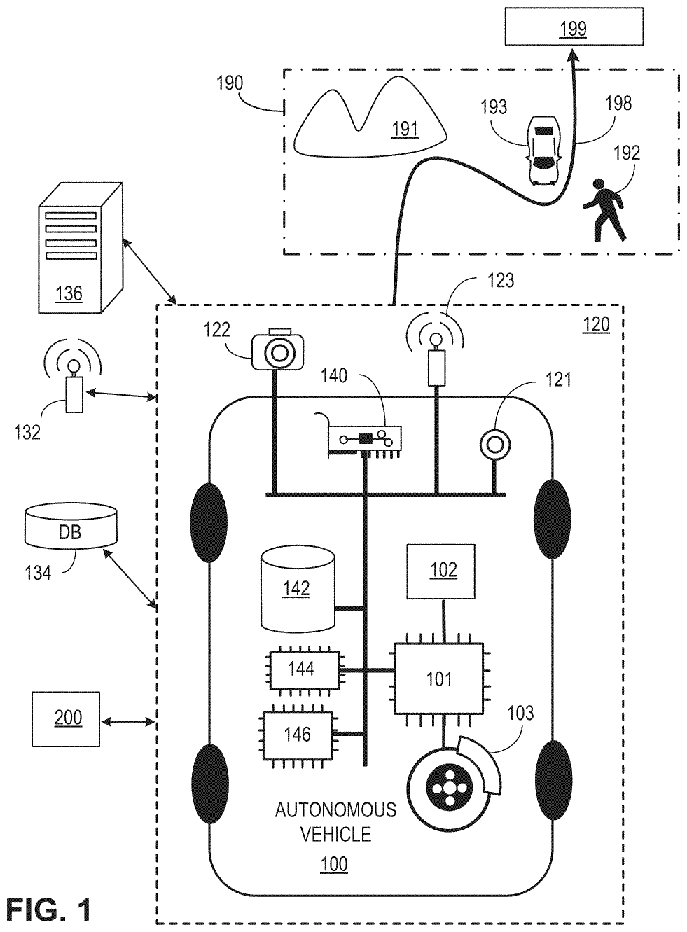

FIG. 1 shows an example of an autonomous vehicle 100 having autonomous capability.

As used herein, the term “autonomous capability” refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, etc. A driverless car is an example of a vehicle.

As used herein, “trajectory” refers to a path or route to navigate an AV from a first spatiotemporal location to second spatiotemporal location. In an embodiment, the first spatiotemporal location is referred to as the initial or starting location and the second spatiotemporal location is referred to as the destination, final location, goal, goal position, or goal location. In some examples, a trajectory is made up of one or more segments (e.g., sections of road) and each segment is made up of one or more blocks (e.g., portions of a lane or intersection). In an embodiment, the spatiotemporal locations correspond to real-world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a random-access memory (RAM) and/or a non-volatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

As used herein, a “road” is a physical area that can be traversed by a vehicle, and may correspond to a named thoroughfare (e.g., city street, interstate freeway, etc.) or may correspond to an unnamed thoroughfare (e.g., a driveway in a house or office building, a section of a parking lot, a section of a vacant lot, a dirt path in a rural area, etc.). Because some vehicles (e.g., 4-wheel-drive pick-up trucks, sport utility vehicles, etc.) are capable of traversing a variety of physical areas not specifically adapted for vehicle travel, a “road” may be a physical area not formally defined as a thoroughfare by any municipality or other governmental or administrative body.

As used herein, a “lane” is a portion of a road that can be traversed by a vehicle. A lane is sometimes identified based on lane markings. For example, a lane may correspond to most or all of the space between lane markings, or may correspond to only some (e.g., less than 50%) of the space between lane markings. For example, a road having lane markings spaced far apart might accommodate two or more vehicles between the markings, such that one vehicle can pass the other without traversing the lane markings, and thus could be interpreted as having a lane narrower than the space between the lane markings, or having two lanes between the lane markings. A lane could also be interpreted in the absence of lane markings. For example, a lane may be defined based on physical features of an environment, e.g., rocks and trees along a thoroughfare in a rural area or, e.g., natural obstructions to be avoided in an undeveloped area. A lane could also be interpreted independent of lane markings or physical features. For example, a lane could be interpreted based on an arbitrary path free of obstructions in an area that otherwise lacks features that would be interpreted as lane boundaries. In an example scenario, an AV could interpret a lane through an obstruction-free portion of a field or empty lot. In another example scenario, an AV could interpret a lane through a wide (e.g., wide enough for two or more lanes) road that does not have lane markings. In this scenario, the AV could communicate information about the lane to other AVs so that the other AVs can use the same lane information to coordinate path planning among themselves.

The term “over-the-air (OTA) client” includes any AV, or any electronic device (e.g., computer, controller, IoT device, electronic control unit (ECU)) that is embedded in, coupled to, or in communication with an AV.

The term “OTA update” means any update, change, deletion or addition to software, firmware, data or configuration settings, or any combination thereof, that is delivered to an OTA client using proprietary and/or standardized wireless communications technology, including but not limited to: cellular mobile communications (e.g., 2G, 3G, 4G, 5G), radio wireless area networks (e.g., WiFi) and/or satellite Internet.

The term “edge node” means one or more edge devices coupled to a network that provide a portal for communication with AVs and can communicate with other edge nodes and a cloud based computing platform, for scheduling and delivering OTA updates to OTA clients.

The term “edge device” means a device that implements an edge node and provides a physical wireless access point (AP) into enterprise or service provider (e.g., VERIZON, AT&T) core networks. Examples of edge devices include but are not limited to: computers, controllers, transmitters, routers, routing switches, integrated access devices (IADs), multiplexers, metropolitan area network (MAN) and wide area network (WAN) access devices.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, an AV system refers to the AV along with the array of hardware, software, stored data, and data generated in real-time that supports the operation of the AV. In an embodiment, the AV system is incorporated within the AV. In an embodiment, the AV system is spread across several locations. For example, some of the software of the AV system is implemented on a cloud computing environment similar to a cloud computing environment.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). The technologies described in this document are also applicable to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). In an embodiment, one or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Autonomous vehicles have advantages over vehicles that require a human driver. One advantage is safety. For example, in 2016, the United States experienced 6 million automobile accidents, 2.4 million injuries, 40,000 fatalities, and 13 million vehicles in crashes, estimated at a societal cost of $910+ billion. U.S. traffic fatalities per 100 million miles traveled have been reduced from about six to about one from 1965 to 2015, in part due to additional safety measures deployed in vehicles. For example, an additional half second of warning that a crash is about to occur is believed to mitigate 60% of front-to-rear crashes. However, passive safety features (e.g., seat belts, airbags) have likely reached their limit in improving this number. Thus, active safety measures, such as automated control of a vehicle, are the likely next step in improving these statistics. Because human drivers are believed to be responsible for a critical pre-crash event in 95% of crashes, automated driving systems are likely to achieve better safety outcomes, e.g., by reliably recognizing and avoiding critical situations better than humans; making better decisions, obeying traffic laws, and predicting future events better than humans; and reliably controlling a vehicle better than a human.

Referring to FIG. 1, an AV system 120 operates the vehicle 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

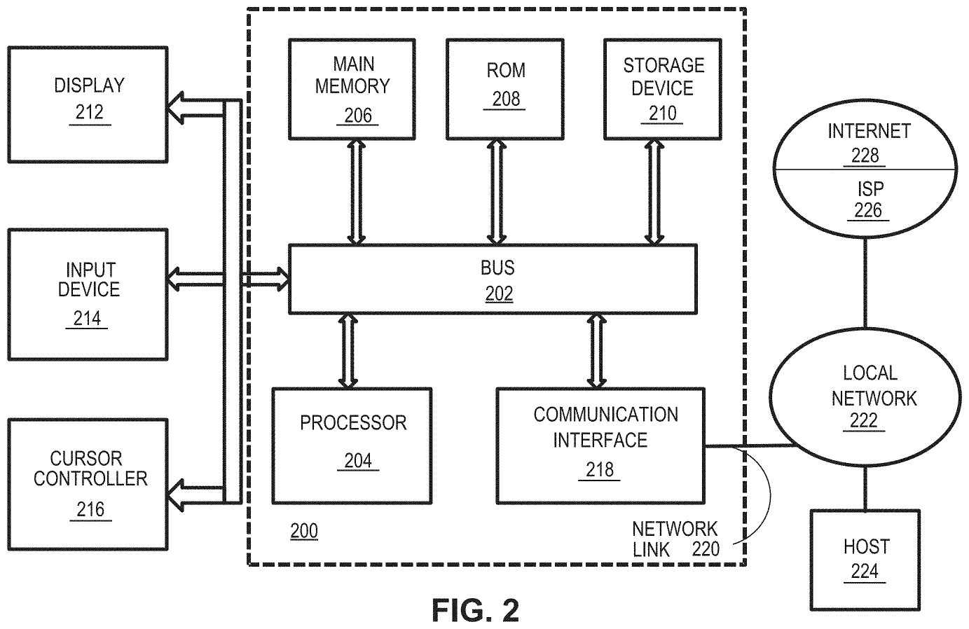

In an embodiment, the AV system 120 includes devices 101 that are instrumented to receive and act on operational commands from the computer processors 146. We use the term “operational command” to mean an executable instruction (or set of instructions) that causes a vehicle to perform an action (e.g., a driving maneuver). Operational commands can, without limitation, including instructions for a vehicle to start moving forward, stop moving forward, start moving backward, stop moving backward, accelerate, decelerate, perform a left turn, and perform a right turn. In an embodiment, computing processors 146 are similar to the processor 204 described below in reference to FIG. 2. Examples of devices 101 include a steering control 102, brakes 103, gears, accelerator pedal or other acceleration control mechanisms, windshield wipers, side-door locks, window controls, and turn-indicators.

In an embodiment, the AV system 120 includes sensors 121 for measuring or inferring properties of state or condition of the vehicle 100, such as the AV's position, linear and angular velocity and acceleration, and heading (e.g., an orientation of the leading end of vehicle 100). Example of sensors 121 are global positioning satellite (GPS), inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 208 or storage device 210 described below in relation to FIG. 2. In an embodiment, memory 144 is similar to the main memory 206 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the vehicle 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the vehicle 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment. The communication devices 140 transmit data collected from sensors 121 or other data related to the operation of vehicle 100 to the remotely located database 134. In an embodiment, communication devices 140 transmit information that relates to teleoperations to the vehicle 100. In some embodiments, the vehicle 100 communicates with other remote (e.g., “cloud”) servers 136.

In an embodiment, the remotely located database 134 also stores and transmits digital data (e.g., storing data such as road and street locations). Such data is stored on the memory 144 on the vehicle 100, or transmitted to the vehicle 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. In one implementation, such data can be stored on the memory 144 on the vehicle 100, or transmitted to the vehicle 100 via a communications channel from the remotely located database 134.

Computer processors 146 located on the vehicle 100 algorithmically generate control actions based on both real-time sensor data and prior information, allowing the AV system 120 to execute its autonomous driving capabilities.

In an embodiment, the AV system 120 includes computer peripherals 132 coupled to computer processors 146 for providing information and alerts to, and receiving input from, a user (e.g., an occupant or a remote user) of the vehicle 100. In an embodiment, peripherals 132 are similar to the display 212, input device 214, and cursor controller 216 discussed below in reference to FIG. 2. The coupling is wireless or wired. Any two or more of the interface devices can be integrated into a single device.

In an embodiment, the AV system 120 receives and enforces a privacy level of a passenger, e.g., specified by the passenger or stored in a profile associated with the passenger. The privacy level of the passenger determines how particular information associated with the passenger (e.g., passenger comfort data, biometric data, etc.) is permitted to be used, stored in the passenger profile, and/or stored on the cloud server 136 and associated with the passenger profile. In an embodiment, the privacy level specifies particular information associated with a passenger that is deleted once the ride is completed. In an embodiment, the privacy level specifies particular information associated with a passenger and identifies one or more entities that are authorized to access the information. Examples of specified entities that are authorized to access information can include other AVs, third-party AV systems, or any entity that could potentially access the information.

A privacy level of a passenger can be specified at one or more levels of granularity. In an embodiment, a privacy level identifies specific information to be stored or shared. In an embodiment, the privacy level applies to all the information associated with the passenger such that the passenger can specify that none of her personal information is stored or shared. Specification of the entities that are permitted to access particular information can also be specified at various levels of granularity. Various sets of entities that are permitted to access particular information can include, for example, other AVs, cloud servers 136, specific third-party AV systems, etc.

In an embodiment, the AV system 120 or the cloud server 136 determines if certain information associated with a passenger can be accessed by the AV 100 or another entity. For example, a third-party AV system that attempts to access passenger input related to a particular spatiotemporal location must obtain authorization, e.g., from the AV system 120 or the cloud server 136, to access the information associated with the passenger. For example, the AV system 120 uses the passenger's specified privacy level to determine whether the passenger input related to the spatiotemporal location can be presented to the third-party AV system, the AV 100, or to another AV. This enables the passenger's privacy level to specify which other entities are allowed to receive data about the passenger's actions or other data associated with the passenger.

FIG. 2 shows a computer system 200. In an implementation, the computer system 200 is a special-purpose computing device. The special-purpose computing device is hard-wired to perform the techniques or includes digital electronic devices such as one or more ASICs or field programmable gate arrays (FPGAs) that are persistently programmed to perform the techniques, or can include one or more general-purpose hardware processors programmed to perform the techniques pursuant to program instructions in firmware, memory, other storage, or a combination. Such special-purpose computing devices can also combine custom hard-wired logic, ASICs, or FPGAs with custom programming to accomplish the techniques. In various embodiments, the special-purpose computing devices are desktop computer systems, portable computer systems, handheld devices, network devices or any other device that incorporates hard-wired and/or program logic to implement the techniques.

In an embodiment, the computer system 200 includes a bus 202 or other communication mechanism for communicating information, and a processor 204 coupled with a bus 202 for processing information. The processor 204 is, for example, a general-purpose microprocessor. The computer system 200 also includes a main memory 206, such as a RAM or other dynamic storage device, coupled to the bus 202 for storing information and instructions to be executed by processor 204. In one implementation, the main memory 206 is used for storing temporary variables or other intermediate information during execution of instructions to be executed by the processor 204. Such instructions, when stored in non-transitory storage media accessible to the processor 204, render the computer system 200 into a special-purpose machine that is customized to perform the operations specified in the instructions.

In an embodiment, the computer system 200 further includes a read only memory (ROM) 208 or other static storage device coupled to the bus 202 for storing static information and instructions for the processor 204. A storage device 210, such as a magnetic disk, optical disk, solid-state drive, or three-dimensional cross point memory is provided and coupled to the bus 202 for storing information and instructions.

In an embodiment, the computer system 200 is coupled via the bus 202 to a display 212, such as a cathode ray tube (CRT), a liquid crystal display (LCD), plasma display, light emitting diode (LED) display, or an organic light emitting diode (OLED) display for displaying information to a computer user. An input device 214, including alphanumeric and other keys, is coupled to bus 202 for communicating information and command selections to the processor 204. Another type of user input device is a cursor controller 216, such as a mouse, a trackball, a touch-enabled display, or cursor direction keys for communicating direction information and command selections to the processor 204 and for controlling cursor movement on the display 212. This input device typically has two degrees of freedom in two axes, a first axis (e.g., x-axis) and a second axis (e.g., y-axis), that allows the device to specify positions in a plane.

According to one embodiment, the techniques herein are performed by the computer system 200 in response to the processor 204 executing one or more sequences of one or more instructions contained in the main memory 206. Such instructions are read into the main memory 206 from another storage medium, such as the storage device 210. Execution of the sequences of instructions contained in the main memory 206 causes the processor 204 to perform the process steps described herein. In alternative embodiments, hard-wired circuitry is used in place of or in combination with software instructions.

The term “storage media” as used herein refers to any non-transitory media that store data and/or instructions that cause a machine to operate in a specific fashion. Such storage media includes non-volatile media and/or volatile media. Non-volatile media includes, for example, optical disks, magnetic disks, solid-state drives, or three-dimensional cross point memory, such as the storage device 210. Volatile media includes dynamic memory, such as the main memory 206. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 202. Transmission media can also take the form of acoustic or light waves, such as those generated during radio-wave and infrared data communications.

In an embodiment, various forms of media are involved in carrying one or more sequences of one or more instructions to the processor 204 for execution. For example, the instructions are initially carried on a magnetic disk or solid-state drive of a remote computer. The remote computer loads the instructions into its dynamic memory and send the instructions over a telephone line using a modem. A modem local to the computer system 200 receives the data on the telephone line and use an infrared transmitter to convert the data to an infrared signal. An infrared detector receives the data carried in the infrared signal and appropriate circuitry places the data on the bus 202. The bus 202 carries the data to the main memory 206, from which processor 204 retrieves and executes the instructions. The instructions received by the main memory 206 can optionally be stored on the storage device 210 either before or after execution by processor 204.

The computer system 200 also includes a communication interface 218 coupled to the bus 202. The communication interface 218 provides a two-way data communication coupling to a network link 220 that is connected to a local network 222. For example, the communication interface 218 is an integrated service digital network (ISDN) card, cable modem, satellite modem, or a modem to provide a data communication connection to a corresponding type of telephone line. As another example, the communication interface 218 is a local area network (LAN) card to provide a data communication connection to a compatible LAN. In some implementations, wireless links are also implemented. In any such implementation, the communication interface 218 sends and receives electrical, electromagnetic, or optical signals that carry digital data streams representing various types of information.

The network link 220 typically provides data communication through one or more networks to other data devices. For example, the network link 220 provides a connection through the local network 222 to a host computer 224 or to a cloud data center or equipment operated by an Internet Service Provider (ISP) 226. The ISP 226 in turn provides data communication services through the world-wide packet data communication network now commonly referred to as the “Internet” 228. The local network 222 and Internet 228 both use electrical, electromagnetic or optical signals that carry digital data streams. The signals through the various networks and the signals on the network link 220 and through the communication interface 218, which carry the digital data to and from the computer system 200, are example forms of transmission media. In an embodiment, the network 220 contains the cloud or a part of the cloud.

The computer system 200 sends messages and receives data, including program code, through the network(s), the network link 220, and the communication interface 218. In an embodiment, the computer system 200 receives code for processing. The received code is executed by the processor 204 as it is received, and/or stored in storage device 210, or other non-volatile storage for later execution.

### Autonomous Vehicle Architecture

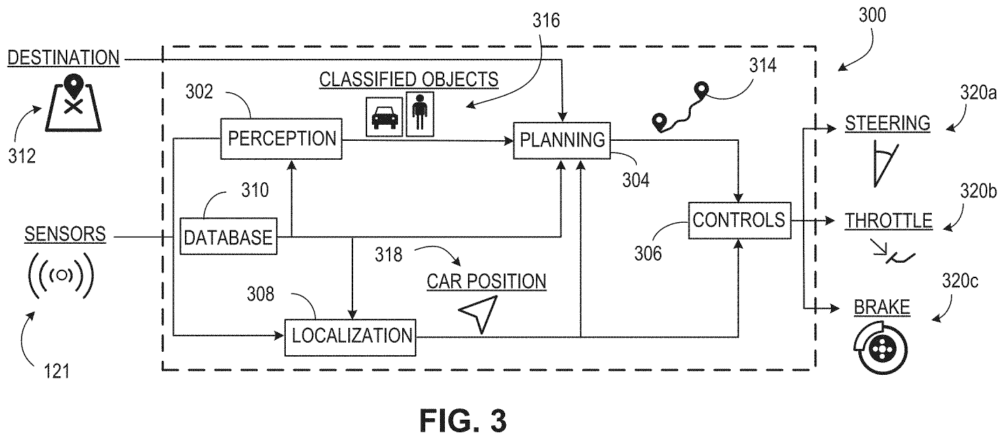

FIG. 3 shows an example architecture 300 for an autonomous vehicle (e.g., the vehicle 100 shown in FIG. 1). The architecture 300 includes a perception system 302 (sometimes referred to as a perception circuit), a planning system 304 (sometimes referred to as a planning circuit), a control system 306 (sometimes referred to as a control circuit), a localization system 308 (sometimes referred to as a localization circuit), and a database system 310 (sometimes referred to as a database circuit). Each system plays a role in the operation of the vehicle 100. Together, the systems 302, 304, 306, 308, and 310 can be part of the AV system 120 shown in FIG. 1. In some embodiments, any of the systems 302, 304, 306, 308, and 310 is a combination of computer software (e.g., executable code stored on a computer-readable medium) and computer hardware (e.g., one or more microprocessors, microcontrollers, application-specific integrated circuits [ASICs]), hardware memory devices, other types of integrated circuits, other types of computer hardware, or a combination of any or all of these things). Each of the systems 302, 304, 306, 308, and 310 is sometimes referred to as a processing circuit (e.g., computer hardware, computer software, or a combination of the two). A combination of any or all of the systems 302, 304, 306, 308, and 310 is also an example of a processing circuit.

In use, the planning system 304 receives data representing a destination 312 and determines data representing a trajectory 314 (sometimes referred to as a route) that can be traveled by the vehicle 100 to reach (e.g., arrive at) the destination 312. In order for the planning system 304 to determine the data representing the trajectory 314, the planning system 304 receives data from the perception system 302, the localization system 308, and the database system 310.

The perception system 302 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 316 is provided to the planning system 304.

The planning system 304 also receives data representing the AV position 318 from the localization system 308. The localization system 308 determines the AV position by using data from the sensors 121 and data from the database system 310 (e.g., a geographic data) to calculate a position. For example, the localization system 308 uses data from a GNSS (Global Navigation Satellite System) sensor and geographic data to calculate a longitude and latitude of the AV. In an embodiment, data used by the localization system 308 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types. In an embodiment, the high-precision maps are constructed by adding data through automatic or manual annotation to low-precision maps.

The control system 306 receives the data representing the trajectory 314 and the data representing the AV position 318 and operates the control functions 320a-c (e.g., steering, throttling, braking, ignition) of the AV in a manner that will cause the vehicle 100 to travel the trajectory 314 to the destination 312. For example, if the trajectory 314 includes a left turn, the control system 306 will operate the control functions 320a-c in a manner such that the steering angle of the steering function will cause the vehicle 100 to turn left and the throttling and braking will cause the vehicle 100 to pause and wait for passing pedestrians or vehicles before the turn is made.

### Autonomous Vehicle Planning

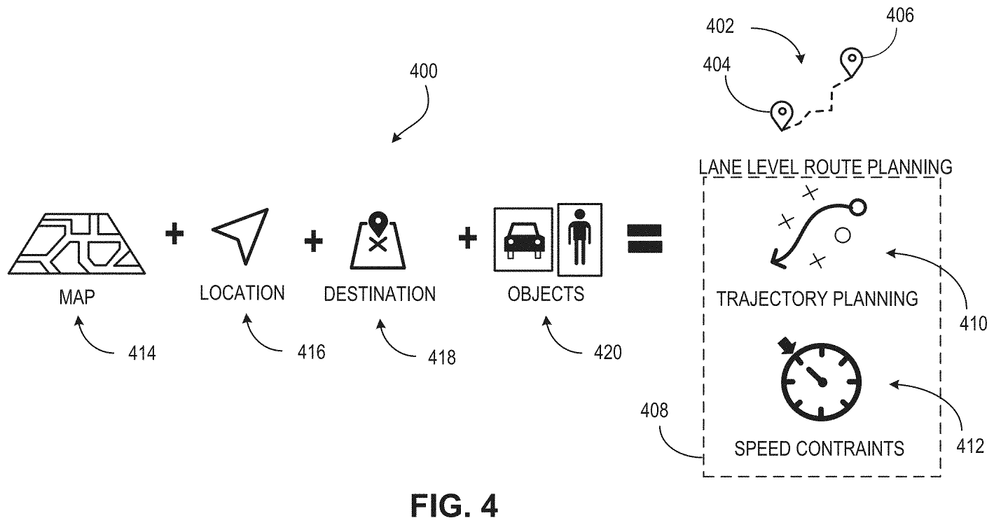

FIG. 4 shows a block diagram 400 of the relationships between inputs and outputs of a planning system 304 (e.g., as shown in FIG. 3). In general, the output of a planning system 304 is a route 402 from a start point 404 (e.g., source location or initial location), and an end point 406 (e.g., destination or final location). The route 402 is typically defined by one or more segments. For example, a segment is a distance to be traveled over at least a portion of a street, road, highway, driveway, or other physical area appropriate for automobile travel. In some examples, e.g., if the vehicle 100 is an off-road capable vehicle such as a four-wheel-drive (4WD) or all-wheel-drive (AWD) car, SUV, pick-up truck, or the like, the route 402 includes “off-road” segments such as unpaved paths or open fields.

In addition to the route 402, a planning system also outputs lane-level route planning data 408. The lane-level route planning data 408 is used to traverse segments of the route 402 based on conditions of the segment at a particular time. For example, if the route 402 includes a multi-lane highway, the lane-level route planning data 408 includes trajectory planning data 410 that the vehicle 100 can use to choose a lane among the multiple lanes, e.g., based on whether an exit is approaching, whether one or more of the lanes have other vehicles, or other factors that vary over the course of a few minutes or less. Similarly, in some implementations, the lane-level route planning data 408 includes speed constraints 412 specific to a segment of the route 402. For example, if the segment includes pedestrians or un-expected traffic, the speed constraints 412 may limit the vehicle 100 to a travel speed slower than an expected speed, e.g., a speed based on speed limit data for the segment.

In an embodiment, the inputs to the planning system 304 includes database data 414 (e.g., from the database system 310 shown in FIG. 3), current location data 416 (e.g., the AV position 318 shown in FIG. 3), destination data 418 (e.g., for the destination 312 shown in FIG. 3), and object data 420 (e.g., the classified objects 316 as perceived by the perception system 302 as shown in FIG. 3). In some embodiments, the database data 414 includes rules used in planning. Rules are specified using a formal language, e.g., using Boolean logic. In any given situation encountered by the vehicle 100, at least some of the rules will apply to the situation. A rule applies to a given situation if the rule has conditions that are met based on information available to the vehicle 100, e.g., information about the surrounding environment. Rules can have priority. For example, a rule that says, “if the road is a freeway, move to the leftmost lane” can have a lower priority than “if the exit is approaching within a mile, move to the rightmost lane.”

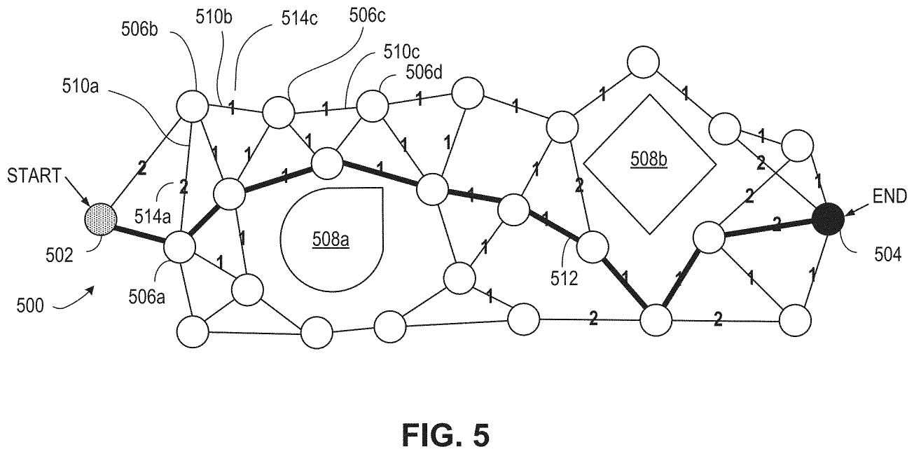

FIG. 5 shows a directed graph 500 used in path planning, e.g., by the planning system 304 (FIG. 3). In general, a directed graph 500 like the one shown in FIG. 5 is used to determine a path between any start point 502 and end point 504. In real-world terms, the distance separating the start point 502 and end point 504 may be relatively large (e.g., in two different metropolitan areas) or may be relatively small (e.g., two intersections abutting a city block or two lanes of a multi-lane road).

In an embodiment, the directed graph 500 has nodes 506a-d representing different locations between the start point 502 and the end point 504 that could be occupied by a vehicle 100. In some examples, e.g., when the start point 502 and end point 504 represent different metropolitan areas, the nodes 506a-d represent segments of roads. In some examples, e.g., when the start point 502 and the end point 504 represent different locations on the same road, the nodes 506a-d represent different positions on that road. In this way, the directed graph 500 includes information at varying levels of granularity. In an embodiment, a directed graph having high granularity is also a subgraph of another directed graph having a larger scale. For example, a directed graph in which the start point 502 and the end point 504 are far away (e.g., many miles apart) has most of its information at a low granularity and is based on stored data, but also includes some high granularity information for the portion of the graph that represents physical locations in the field of view of the vehicle 100.

The nodes 506a-d are distinct from objects 508a-b which cannot overlap with a node. In an embodiment, when granularity is low, the objects 508a-b represent regions that cannot be traversed by automobile, e.g., areas that have no streets or roads. When granularity is high, the objects 508a-b represent physical objects in the field of view of the vehicle 100, e.g., other automobiles, pedestrians, or other entities with which the vehicle 100 cannot share physical space. In an embodiment, some or all of the objects 508a-b are a static objects (e.g., an object that does not change position such as a street lamp or utility pole) or dynamic objects (e.g., an object that is capable of changing position such as a pedestrian or other car).

The nodes 506a-d are connected by edges 510a-c. If two nodes 506a-b are connected by an edge 510a, it is possible for a vehicle 100 to travel between one node 506a and the other node 506b, e.g., without having to travel to an intermediate node before arriving at the other node 506b. (When we refer to a vehicle 100 traveling between nodes, we mean that the vehicle 100 travels between the two physical positions represented by the respective nodes.) The edges 510a-c are often bidirectional, in the sense that a vehicle 100 travels from a first node to a second node, or from the second node to the first node. In an embodiment, edges 510a-c are unidirectional, in the sense that an vehicle 100 can travel from a first node to a second node, however the vehicle 100 cannot travel from the second node to the first node. Edges 510a-c are unidirectional when they represent, for example, one-way streets, individual lanes of a street, road, or highway, or other features that can only be traversed in one direction due to legal or physical constraints.

In an embodiment, the planning system 304 uses the directed graph 500 to identify a path 512 made up of nodes and edges between the start point 502 and end point 504.

An edge 510a-c has an associated cost 514a-b. The cost 514a-b is a value that represents the resources that will be expended if the vehicle 100 chooses that edge. A typical resource is time. For example, if one edge 510a represents a physical distance that is twice that as another edge 510b, then the associated cost 514a of the first edge 510a may be twice the associated cost 514b of the second edge 510b. Other factors that affect time include expected traffic, number of intersections, speed limit, etc. Another typical resource is fuel economy. Two edges 510a-b may represent the same physical distance, but one edge 510a may require more fuel than another edge 510b, e.g., because of road conditions, expected weather, etc.

When the planning system 304 identifies a path 512 between the start point 502 and end point 504, the planning system 304 typically chooses a path optimized for cost, e.g., the path that has the least total cost when the individual costs of the edges are added together.

### Trajectory Planning

As previously noted, a purely sampling-based approach, and particularly a time-parameterized approach, to path planning may be inefficient, or may encounter difficulties in situations where the velocity of the vehicle is very low or approaching zero, or where the paths are constricted. Embodiments herein provide a technique to mitigate these concerns with a constraints computation system and a MPC system. The constraints computation system applies at least one constraint to a reference path to identify one potential path through the environment. The MPC system identifies another potential path based on spatial optimization of the reference path. The two potential paths are then compared to identify which path should be used by the vehicle for navigation.

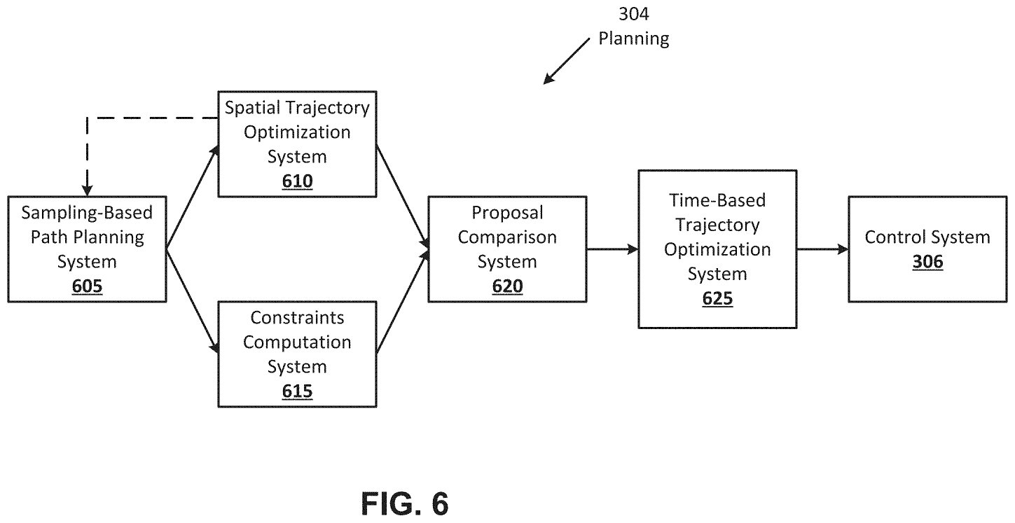

FIG. 6 shows an example path planning system, in accordance with various embodiments. Specifically, FIG. 6 depicts a detailed example of the planning system 304 of FIG. 3. The planning system 304 includes a number of subsystems as depicted in FIG. 6. The various subsystems may be implemented by hardware, software, firmware, or some combination thereof. In an embodiment, each subsystem of the planning system 304 is implemented in a single circuit, a single processor, a single processor core, etc. In another embodiment, one or more of the subsystems of the planning system 304 are implemented on a different circuit/processor/processor core than another of the subsystems. It will also be noted that this depiction of a planning system 304 is intended as a high-level example embodiment for the sake of discussion herein. Other embodiments may have a different number of elements, or elements arranged in a different configuration than depicted in FIG. 6.

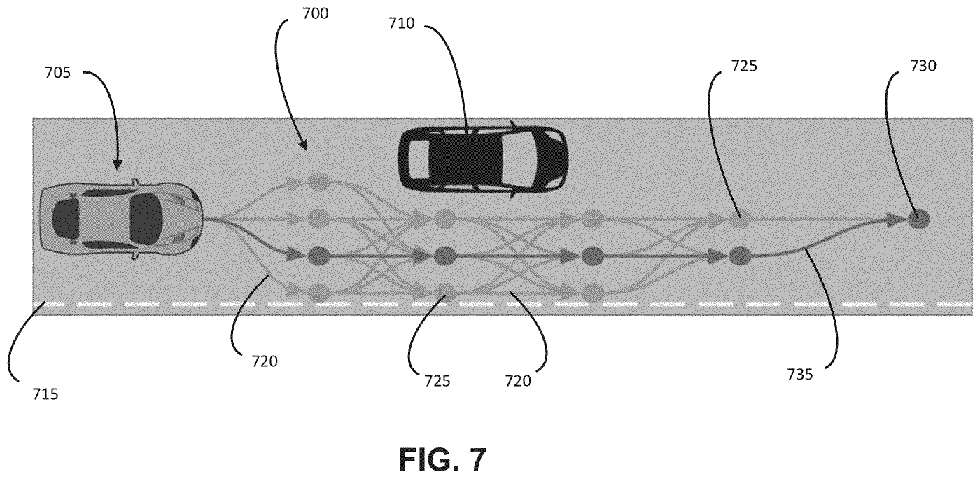

The planning system 304 includes a sampling-based path planning system 605. The sampling-based path planning system 605 is to generate a directed graph that includes a series of nodes and edges. FIG. 7 shows an example of such a directed graph 700 to be used in path planning, in accordance with various embodiments. The graph 700 is used to identify a path for traversal of a vehicle from the starting point 705 (at which the vehicle is pictured in FIG. 7) to end point 730. However, as may be seen in FIG. 7, the traversal of the vehicle from its starting point 705 to the end point at 730 is limited by factors such as a lane marker 715 of the road, or an obstacle 710. It will be understood that this graph 700 is intended as a highly simplified example, and other embodiments may include additional limitations or a different type of limitation (e.g., a bicyclist, a pedestrian, a traffic-based limitation such as a stop sign, etc.) or objects 508a or 508b.

The graph 700 is similar to, and shares one or more characteristics with, the graph 500 of FIG. 5. Specifically, the graph 700 includes a number of edges 720 and nodes 725, which are respectively similar to, and share one or more characteristics with, edges 510a-c and nodes 506a-d. Specifically, the edges 720 represent different trajectories of travel between the nodes 725, which represent physical locations.

The sampling-based path planning system 605 will further identify a reference path 735 through the graph 700. The reference path 735 is based on, for example, a sampling-based approach. As used herein, a “sampling-based approach” refers to an approach wherein the sampling-based path planning system 605 samples various points of the graph 700 until a path between the starting point 705 of the vehicle at and the end point 730 is found. In some embodiments, the sampling can be random or quasi-random, whereas in other embodiments the sampling is directed with heuristics or done from a set of particular motion priors. The sampling-based path planning system 605 outputs the graph 700 as well as the reference path 735 (or an indication thereof) to a constraints computation system 615 and a spatial trajectory optimization system 610 (which may also be referred to as a spatial MPC system).

The constraints computation system 615 is to calculate one or more constraints that are to be applied to the reference path 735. For example, the constraints include constraints such as velocity-based constraints such as a maximum speed of the vehicle based on various conditions (traffic, weather, whether the vehicle is going straight or rounding a corner, etc.). Another example of constraints includes constraints based on various objects such as obstacle 710. For example, the constraints may relate to spatial-based constraints wherein the location of the vehicle is constrained to avoid collisions. Another example of constraints includes constraints such as lane constraints, for example as imposed by the lane marker 715. In order to impose these constraints, the constraints computation system 615 may aggregate data from various sources such as the graph 700 or reference path 735 provided by the sampling-based path planning system 605, information provided by one or more of the sensors 121 described above (e.g., information from a LiDAR system, a radar system, a camera, etc.), information based on an accelerometer or gyroscope of the vehicle, GPS information, etc.

The spatial trajectory optimization system 610 is configured to use, as inputs, one or both of the reference path 735 and the graph 700 output by the path planning system 605. As described in further detail below, the spatial trajectory optimization system 610 is referred to as “gradient-based.” The spatial trajectory optimization system 610 then is configured to identify an alternative path between the starting point 705 and the end point 730. Specifically, in order to identify this alternative path, the spatial trajectory optimization system 610 is configured to consume the data related to the reference path 735 and the graph 700 into a spatial domain rather than the classical time parameterization that is typically used for MPC.

Specifically, the motion of the vehicle is modeled in the spatial-domain based on a model such as a spatial kinematic bicycle model. The spatial kinematic bicycle model is a vehicle model that uses station-based state variables such as lateral error, local heading, velocity, acceleration, or steering angle of the vehicle. In an embodiment, the model also uses input variables such as change in acceleration or change in steering. Additionally, in an embodiment the model also uses variables related to slack in the system such as slack on lateral error, slack on velocity, or slack on acceleration.

As used herein, the term “slack” refers to an acceptable level of constraints satisfaction. Specifically, slack variables are other decision variables the optimizer can alter that allow some slack on constraints of the optimization problem. The slack represents that at certain cost, some constraints can be violated. This ability to violate certain constraints allows, for example, implementation of traffic rule/safety prioritization.

The vehicle states are described in a local coordinate frame, where variables are described with respect to some reference path (this is particular to our implementation). The “lateral error” state represents the position of the vehicle laterally from the reference path.

It will be understood that these variables are described as example variables and other embodiments may use more or fewer variables, different variables, etc. to provide a spatial-domain model of the vehicle's behavior from the starting point 705 to the end point 730.

The spatial trajectory optimization system 610 is configured to optimize the vehicle states over a prediction horizon to identify a second path, which is referred to herein as the “spatial-based path.” For example, optimization of the model is based on one or more of the following components:

A first component is free variables that the optimization is trying to find optimal values for. These free variables are typically the vehicle states over a given prediction horizon.

A second component is use of the vehicle model as an equality constraint. To put it another way, the evolution of vehicle states over the prediction horizon are required to satisfy the vehicle model. An optimal sequence of vehicles states that results from the optimization will therefore adhere to the vehicle model.

A third component is an objective function that encodes the cost associated with certain combinations of optimization variables. The objective function is generally pre-identified based on desired behavior of the vehicle. Typically, the objective function relates to one or more factors such as passenger comfort, reference tracking, or clearance from obstacles.

The fourth component is constraints the bound the free variables (as discussed above with respect to the first component) to a particular feasible set. These constraints describe parameters within which the optimal solution must be found. Constraints model, for example, lane boundaries, collision constraints, speed constraints, actuation constraints (throttle, braking, or steering), etc.

The details of the environment and the current vehicle state are then processed into the optimization problem for each iteration that is to be solved by the spatial trajectory optimization system 610. The solution of the optimization problem is a sequence of vehicle states that is optimal with respect to the objective function (e.g., the third component described above) subject to the constraints (e.g., the fourth component described above). Typically, this optimization technique is referred to as “gradient-based,” because the objective function (e.g., the third component described above) is a smooth functional representation that allows the model to move over the surface of the function and follow the gradients of the function to identify an optimal solution.

In one embodiment, it will be recognized that the planning system 304 iterates in accordance with a given time interval. That is, the planning system 304 updates one or more of the graph 700, the reference path 735, etc. at a given frequency which may be, for example 1 hertz. In other embodiments, the frequency may be higher or lower dependent on factors such as the hardware used in the vehicle, the current state of traffic or weather, or other latency requirements. For this iteration, the spatial-based path may be provided to the sampling-based path planning system 605 for use in the next iteration of identifying the reference path (or a part thereof). In one embodiment, the sampling-based path planning system 605 adopts the spatial-based path as the reference path. In another embodiment, the sampling-based path planning system 605 adopts only a portion of the spatial-based path as the reference path, or uses the spatial-based path as a starting point for sampling. Other variations may be present in other embodiments.

The spatial-based path is provided from the spatial trajectory optimization system 610 to a proposal comparison system 620. Similarly, based on the application of the constraints computation system 615 to the sampling-based reference path 735, the constraints computation system outputs a constrained reference path to a proposal comparison system 620. The proposal comparison system 620 receives the paths from the constraints computation system 615 and the spatial trajectory optimization system 610 and compares the paths. Specifically, the constraints computation system 615 compares the constrained reference path and the spatial-based path using one or more rulebooks. The rulebooks relate to various factors such as collision avoidance, rules-of-the-road, etc. Specifically, the rules are applied to each of the paths and then a metric or value is generated based on that application. In an example, a rule relating to collision avoidance may be applied to each of the paths and (a) for each path where a collision is determined to exist, the metric or value generated may be zero (e.g., representing no adherence to the rule) and (b) for each path where a collision is not determined to exist, the metric or value generated may be non-zero (e.g., a value of 1 indicating that no collision would occur, a value greater than zero and less than one representing a degree to which a collision is likely to occur, and/or the like). In another example, a rule relating to a rule-of-the-road (e.g., crossing a line dividing two lanes of opposing traffic) may be applied to each path and (a) for each path where the rule-of-the-road is adhered to, the metric or value generated may be non-zero (e.g., representing adherence to the rule, a degree of adherence to the rule, and/or the like) and (b) for each path where the rule-of-the-road is not adhered to, the metric or value generated may be zero (e.g., representing that adherence to the rule is not possible for a given path). The metrics or values are then analyzed to identify which of the two supplied paths most closely corresponds to the rules of the rulebooks. In an embodiment, the rulebooks are pre-identified or include pre-identified rules as described above. In another embodiment, one or more rulebooks are used that include dynamic rules, e.g. rules that are generated based on traffic conditions, weather conditions, etc. As used herein, a “pre-identified” rule relates to a rule that is identified prior to analysis in accordance with the rule. Such a rule may include, for example, known rules of the road, rules related to collision avoidance strategies, etc. By contrast, a “dynamic” rule may relate to a rule that is based on a current situation related to the vehicle or environment. Such a dynamic rule may, as described above, relate to current traffic conditions, current weather conditions, etc.

Based on the application of the rules from the rulebooks to the paths, and the corresponding metrics or values, one of the two paths provided to the proposal comparison system 620 is selected for use by the vehicle. In an embodiment, selection of the paths is based on which of the two paths receives the “best” score based on the comparison of the rules to the paths. Dependent on how the metrics or values are generated, the best score may be based on a highest or lowest score, with the highest or lowest score representing the path that most adheres to the rules included in the rulebook. In an embodiment, selection of the paths may be based on comparison of the metrics or values to a threshold value (which may be pre-identified or dynamic). For example, in an embodiment the metrics or scores of each path may be analyzed to see if the metrics or scores of each path are greater than (or greater than or equal to) the threshold value. In another embodiment, the analysis may be to see if the metrics or scores of each path are less than (or less than or equal to) the threshold value, dependent on how the metrics are calculated. For the sake of this discussion, it will be assumed that the metric “passes” if its value is greater than the threshold value. If the metrics or values for only one of the paths is greater than the threshold value, then that path is selected as the path to be used by the vehicle. If the metrics or values for both paths are greater than the threshold value, then both paths are selected. If the metrics or values for neither path is greater than the threshold value, a remedial action may be taken such as an emergency stop, re-calculation of the path, or some other remedial action. It will be understood that this example is intended to only describe one example embodiment of operation, and other embodiments may vary.

The proposal comparison system 620 then outputs all or part of the selected path, or an indication thereof, to a time-based trajectory optimization system 625. The time-based trajectory optimization system 625 is configured to compute a trajectory based on the selected path (e.g., the constrained reference path or the spatial-based path selected by the proposal comparison system 620). As used herein, the trajectory refers to information such as the path, velocity or acceleration information, etc. Information regarding the trajectory is then provided to the control system 306 which is configured to operate the vehicle in accordance with the path.

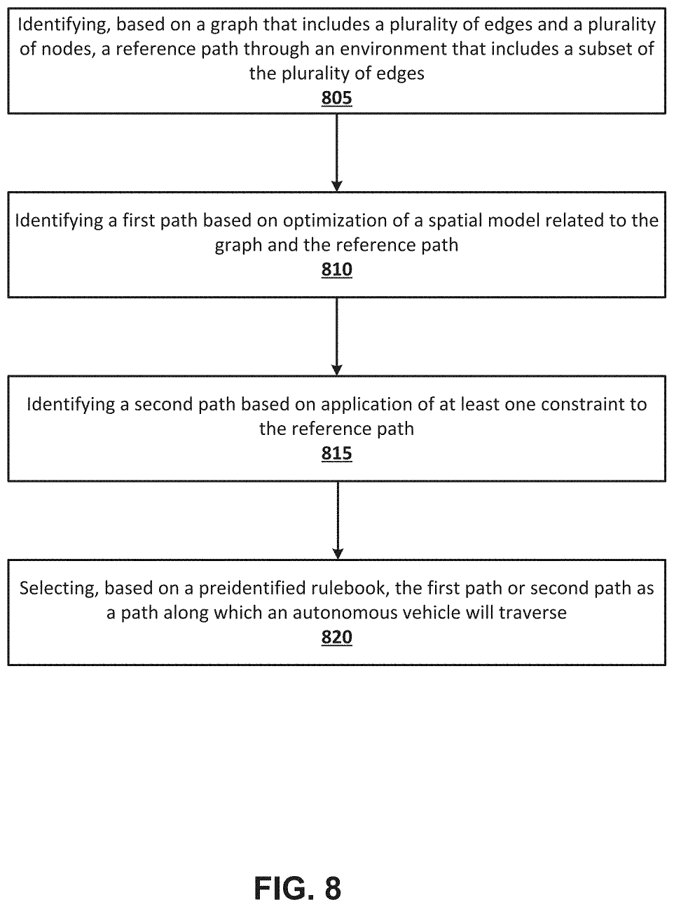

FIG. 8 shows an example technique for path planning, in accordance with various embodiments. The technique of FIG. 8 is performed by, for example, planning system 304 and, more specifically, the various subsystems of planning system 304 as described above with respect to FIG. 6.

It will be understood that this depicted technique is intended as one example of such a technique of path planning, and other embodiments may have more or fewer elements than those depicted in FIG. 8. In other embodiments, certain of the elements may occur in a different order than depicted, or concurrently with one another. Other variations may be present in other embodiments.

The technique includes identifying, at 805, based on a graph that includes a plurality of edges and a plurality of nodes, a reference path through an environment that includes a subset of the plurality of edges. The graph can include, for example, a graph that is the same as or similar to graph 700. The edges and nodes can include, for examples, edges and nodes that are the same as or similar to edges 720 and nodes 725. The reference path can include, for example, a reference path that is the same as or similar to reference path 735.

The technique further include identifying, at 810, a first path based on optimization of a spatial model related to the graph and the reference path. This first path can include, for example, a spatial-based path that is the same as or similar to the spatial-based path described above produced by the spatial trajectory optimization system 610.

The technique further includes identifying, at 815, a second path based on application of at least one constraint to the reference path. The second path can include, for example, a second path that is the same as or similar to the constrained reference path produced by the constraints computation system 615.

The technique further includes selecting, at 820 based on a pre-identified rulebook, the first path or second path as a path along which an autonomous vehicle will traverse. The selection can be the same as or similar to, for example, the selection described above with respect to the proposal comparison system 620 at FIG. 6. Specifically, the selection may be based on comparison of the paths with a pre-identified rulebook to generate a comparison value or metric. In other embodiments, the comparison may be based on a different technique or algorithm.

In the foregoing description, embodiments of the disclosure have been described with reference to numerous specific details that may vary from implementation to implementation. The description and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A system for use in a vehicle, wherein the system comprises:
at least one processor; and
at least one non-transitory computer-related media comprising instructions that, upon execution of the instructions by the at least one processor, are to cause the at least one processor to:
identify, based on a graph that includes a plurality of edges and a plurality of nodes, a reference path through an environment that includes a subset of the plurality of edges;
identify, based on optimization of a spatial model related to the graph and the reference path, a first path;
identify, based on application of at least one constraint to the reference path, a second path; and
select, based on a pre-identified rulebook, the first path or the second path as a path along which the vehicle will traverse.

2. The system of claim 1, wherein the instructions further cause the at least one processor to:
provide an indication of the first path to a path planning system; and
identify, by the path planning system, a subsequent reference path based on at least a portion of the first path.

3. The system of claim 1, wherein the instructions further cause the at least one processor to identify the first path based on velocity constraints, lane constraints, or obstacles in the environment.

4. The system of claim 1, wherein the instructions further cause the at least one processor to identify the second path based on velocity constraints, lane constraints, or obstacles in the environment.

5. The system of claim 1, wherein the pre-identified rulebook includes rules related to collision avoidance or traffic laws.

6. The system of claim 1, wherein the instructions further cause the at least one processor to identify a trajectory based on the selected first or second path.

7. The system of claim 6, wherein the instructions further cause the at least one processor to output at least one indication of a control to be used by a control system of the vehicle.

8. A method comprising:
identifying, by at least one processor of a vehicle based on a graph that includes a plurality of edges and a plurality of nodes, a reference path through an environment that includes a subset of the plurality of edges;
identifying, by the at least one processor, a first path based on optimization of a spatial model related to the graph and the reference path;
identifying, by the at least one processor, a second path based on application of at least one constraint to the reference path; and
selecting, by the at least one processor, the first path or the second path as a path along which the vehicle will traverse based on a pre-identified rulebook.

9. The method of claim 8, further comprising identifying, by the at least one processor, a subsequent reference path based on the first path.

10. The method of claim 8, further comprising identifying, by the at least one processor, the first path or the second path based on velocity constraints, lane constraints, or obstacles in the environment.

11. The method of claim 8, wherein the pre-identified rulebook includes rules related to collision avoidance or traffic laws.

12. The method of claim 8, wherein the method further comprises identifying, by the at least one processor, a trajectory that includes a velocity-based on the selected first or second path.

13. The method of claim 12, further comprising controlling, by the at least one processor, the vehicle based on the trajectory.

14. One or more non-transitory computer-readable media comprising instructions that, upon execution of the instructions by at least one processor of a vehicle, are to cause the vehicle to:
identify, based on a graph that includes a plurality of edges and a plurality of nodes, a reference path through an environment that includes a subset of the plurality of edges;
identify a first path based on optimization of a spatial model related to the graph and the reference path;
identify a second path based on application of at least one constraint to the reference path; and
select, based on a pre-identified rulebook, the first path or second path as a path along which an autonomous vehicle will traverse.

15. The one or more non-transitory computer-readable media of claim 14, wherein the instructions are further to identify a subsequent reference path based on the first path.

16. The one or more non-transitory computer-readable media of claim 14, wherein the instructions are further to identify the first path based on velocity constraints, lane constraints, or obstacles in the environment.

17. The one or more non-transitory computer-readable media of claim 14, wherein the instructions are further to identify the second path based on velocity constraints, lane constraints, or obstacles in the environment.

18. The one or more non-transitory computer-readable media of claim 14, wherein the pre-identified rulebook includes rules related to collision avoidance or traffic laws.

19. The one or more non-transitory computer-readable media of claim 14, wherein the instructions are further to identify a trajectory that includes a velocity-based on the selected first or second path.

20. The one or more non-transitory computer-readable media of claim 19, wherein the instructions are further to cause the vehicle to traverse the selected first or second path in accordance with the identified trajectory.
